(19) United States
(12) Patent Application Publication
(10) Pub. No.: US 2018/0090964 A1
(43) Pub. Date: Mar. 29, 2018

(54) APPARATUS FOR POWERING AN ELECTRICAL DEVICE FROM DIFFERENT BATTERY PACKS

(71) Applicant: Jonathan Henry Williams, Azusa, CA (US)

(72) Inventor: Jonathan Henry Williams, Azusa, CA (US)

(21) Appl. No.: 15/808,819

(22) Filed: Nov. 9, 2017

Related U.S. Application Data
(60) Provisional application No. 62/401,240, filed on Sep. 29, 2016.

(51) Int. Cl. H02J 7/00; H01R 31/02; H01R 31/06; H01M 2/10; H01M 2/30; H01M 2/20

(52) U.S. Cl. CPC H02J 7/0065; H01R 31/02; H01R 31/06; H02J 2007/0067; H01M 2/30; H01M 2/202; H01M 2/1016

(57) ABSTRACT

An apparatus for powering an electrical device from different type battery packs is presented. The device includes a housing with a power management unit within the housing and a plurality of input connectors. The power management unit includes an input terminal and one or more output terminals. Each input connector is coupled to the input terminal of the power management unit. Each input connector is configured to be removably and securely coupled, electrically and mechanically, to terminal contacts of a distinct connector type battery pack of a cordless tool device with voltage ranging from about 4 volts DC to about 25 volts DC. The device includes one or more USB output ports coupled to the one or more output terminals of the power management unit to provide a fixed power source for powering electronic devices, such as smartphones and tablets, in the field.

### CROSS-REFERENCE TO RELATED APPLICATIONS

The present application claims the benefit of U.S. Provisional Application Ser. No. 62/401,240, filed on Sep. 29, 2016, specification of which is herein incorporated by reference for completeness of disclosure.

### BACKGROUND OF THE INVENTION

### Field of the Invention

Embodiments of the invention relates to the field of power devices. More specifically, the invention relates to apparatus for powering an electrical device from different portable equipment battery packs.

### Description of the Related Art

People need to charge and/or power electronic devices more than ever. When they are not near an electrical outlet, e.g., in the field and on job locations, this becomes very difficult, and the options to the consumer are few. In addition, the need to charge or otherwise power personal electronics regardless of physical location has been on the rise for several years and is showing no sign of slowing down.

Contributing factors include increased usage and reliance on technology by society. Also, more people carry more than one powered device thus increasing the number of devices per person. While the number of devices are increasing, each device is getting larger and more powerful and therefore demanding more energy. Moreover, because of battery technology, removable or “swap-able” batteries are becoming less common in mobile devices.

To solve these problems, portable USB chargers and power banks were introduced. However, these devices have on-board batteries that cannot be removed or swapped and are typically single purpose devices that provide extra power just for the smart device.

USB power banks run out of power quickly and then need to be recharged via USB which is very slow (can take up to 24 hours). Consumers who choose this option are buying new lithium cells and have no way of utilizing other lithium cells that they may already own. This is an unnecessary expense for the consumer and has the negative environmental impact that it took to produce those new lithium cells.

Also, some cordless tool manufacturers make USB power-sources that make use of large, swap-able, batteries, which are limited to their specific battery type. Thus, each available prior art system is customized for a single specific battery pack connector and would not securely couple to a different battery pack connector.

To overcome the problems and limitations described above there is a need for the consumer to be able to use powerful, swap-able, and quick-to-charge battery packs from multiple manufacturers for power needs of their electronic devices.

### BRIEF SUMMARY OF THE INVENTION

One or more embodiments of the invention is directed to a universal apparatus for powering an electrical device from different battery pack types.

The need to charge or otherwise power personal electronics regardless of physical location has been on the rise for several years and is showing no sign of slowing down. In particular, people need to charge and/or power electronic devices more than ever. When they are not near an electrical outlet, this becomes very difficult, and the options to the consumer are few.

Embodiments of the present invention, allows a user to charge and/or power electronics anywhere by utilizing the most power-dense and economical batteries available to consumers, i.e. cordless power-tool batteries. For instance, a construction worker on the top of a high-rise complex under construction may not have any available power sources to charge his/her smartphone, but he/she has a cordless hand tool for the job.

One or more embodiments of the invention is a universal power device with a housing. The housing is preferably rectangular in shape and includes an inside cavity with a power management unit. The power management unit has an input terminal with positive (+ve) and negative (−ve, or Ground) contacts, and one or more output terminals. The power management unit is configured to accept input voltage ranging from about 4 Volts DC to about 25 Volts DC. The power management unit may be a Buck converter, a Boost converter, a Buck-Boost converter, or similar voltage regulating device.

In one or more embodiments, the housing further comprises one or more input connectors with conductors coupled to the contacts of the input terminal of the power management unit. Each one of the one or more input connectors is configured to be removably and securely coupled, electrically and mechanically, to terminal contacts of a distinct battery pack type of a cordless tool device.

For example, the one or more input connectors may comprise a first input connector on the housing coupled to the input terminal of the power management unit, with the first input connector configured to be removably and securely coupled, electrically and mechanically, to terminal contacts of a first distinct battery pack type with a wide DC voltage range.

The device may also comprise a second input connector on the housing coupled to the input terminal of the power management unit, with the second input connector configured to be removably and securely coupled, electrically and mechanically, to terminal contacts of a second distinct battery pack type with a wide DC voltage range.

In one or more embodiments, the housing further comprises one or more output ports coupled to the one or more output terminals of the power management unit. The output port may be a USB port, for instance.

In one or more embodiments, the universal power device further comprises an adapter coupleable to the housing and configured to fit and couple to terminals of other specific types of battery packs.

### BRIEF DESCRIPTION OF THE DRAWINGS

The above and other aspects, features and advantages of the invention will be more apparent from the following more particular description thereof, presented in conjunction with the following drawings wherein:

FIG. 1A is a front side perspective view of the universal power device in accordance with one or more embodiments of the present invention.

FIG. 1B is a bottom side perspective view of the universal power device in accordance with one or more embodiments of the present invention.

FIG. 2 is an exploded view of the universal power device in accordance with one or more embodiments of the present invention.

FIG. 3 is a circuit diagram of the power management unit of the universal power device in accordance with one or more embodiments of the present invention.

FIGS. 4A and 4B are illustrations of coupling the universal power device in accordance with one or more embodiments of the present invention to a first cordless power pack.

FIGS. 5A and 5B are illustrations of coupling the universal power device in accordance with one or more embodiments of the present invention to a second cordless power pack.

FIGS. 6A and 6B are illustrations of coupling the universal power device in accordance with one or more embodiments of the present invention to a third cordless power pack using an adapter.

FIGS. 7A and 7B are illustrations of coupling the universal power device in accordance with one or more embodiments of the present invention to a fourth cordless power pack using an adapter.

FIGS. 8A and 8B are illustrations of coupling the universal power device in accordance with one or more embodiments of the present invention to a fifth cordless power pack using an adapter.

FIG. 9 is an illustration of coupling the universal power device in accordance with one or more embodiments of the present invention to a smart device.

FIG. 10 is an illustration of the universal power device with AC Voltage outputs in accordance with one or more embodiments of the present invention.

### DETAILED DESCRIPTION

The present invention comprising a universal apparatus for powering an electrical device from different battery packs will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

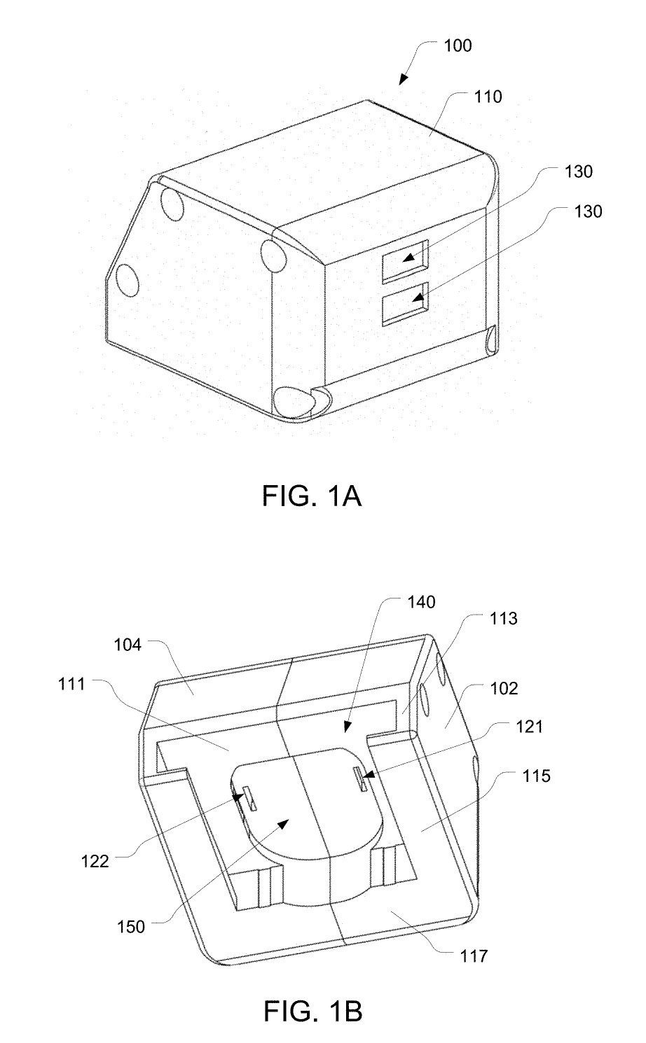

One or more embodiments of the present invention will now be described with references to FIGS. 1-10.

The need to charge or otherwise power personal electronics regardless of physical location has been on the rise for several years and is showing no sign of slowing down. In particular, people need to charge and/or power electronic devices more than ever. When they are not near an electrical outlet, this becomes very difficult, and the options to the consumer are few.

Embodiments of the present invention, allows a user to charge and/or their power electronics device anywhere by utilizing the most power-dense and economical batteries available to the consumer, i.e. cordless power-tool batteries. For instance, a construction worker on the top of a high-rise complex under construction may not have any available power source to charge his/her smartphone, but he/she has a cordless hand tool for the job.

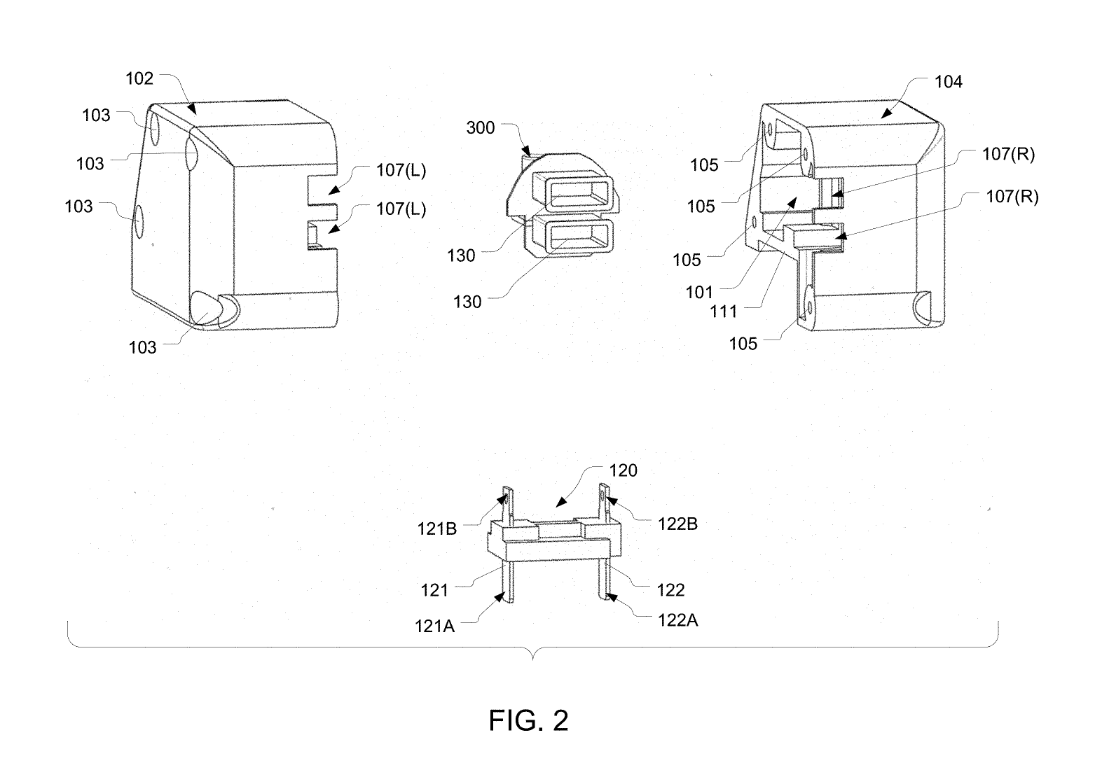

FIGS. 1A and 1B are illustrations of different views of the universal power device 100 in accordance with one or more embodiments of the present invention and FIG. 2 is an exploded view showing the components of the universal power device 100. As illustrated, device 100 comprises a housing 110, respectively; one or more output connector ports 130; and input connector 120.

As illustrated in FIG. 2, housing 110 comprises a left side body 102 and a complementary right side body 104 that are coupled together using one or more coupling screws (not shown) via one or more coupling holes 103 which runs from the left side through to the right side of body 102 and one or more complementary coupling holes 105 which runs from the right side through to the left side of body 104. The left and right side bodies may be coupled together with a bolt and nut combination or any other coupling means. For example, the holes 105 on the right side body 104 may comprise threaded holes for coupling the left side body 102 using screws.

Inside housing 110 is a cavity 101 for retaining the one or more output connector ports 130; an input connector 120; and a power management unit 300. The cavity 101 is configured to hold the components together in the correct position and orientation.

As illustrated in FIG. 1B, the dimensions of the rear and bottom of the housing 110 is configured to engage with multiple distinct battery pack types.

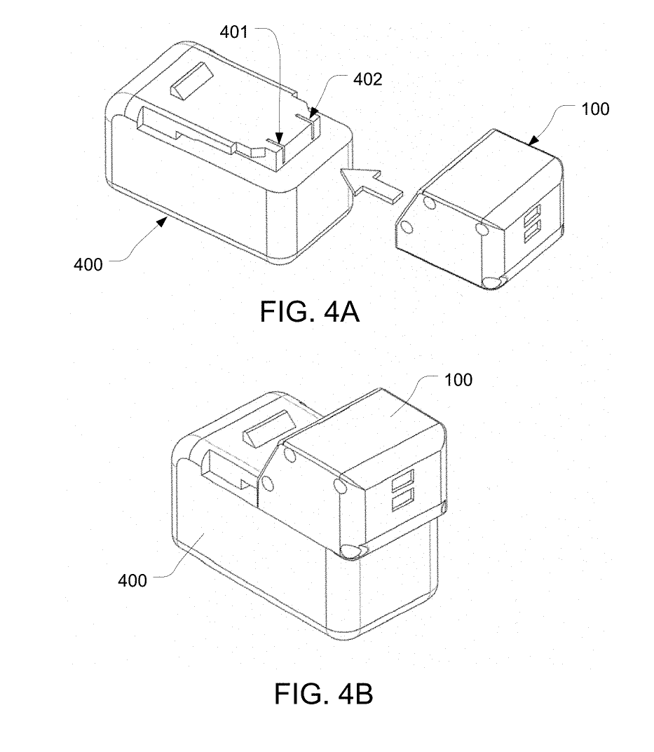

In one or more embodiments, housing 110 is substantially rectangular in shape and comprises an outer bottom wall 111 from which outer sidewall 113 extends downwardly therefrom on the left and right side of the outer bottom wall 111, and terminating in an inwardly extending peripheral flange 115 to form a first female connector 140. The first female connector 140, on the bottom side of the housing, is closed off by a back wall 117, which extends downwardly from the bottom wall 111, and terminating at the flange 115. The first female connector 140, with the terminating flange 115, provides for removably secured mechanical coupling of the housing 110 to a first distinct type male connector of a battery pack assembly by horizontally sliding the housing 110 onto the first distinct type battery pack's male connector. The first female connector 140 comprises a plurality of electrical contacts, e.g. pins 121 and 122, which are configured to securely and electrically engage with the electrical contacts of the battery pack 400, e.g. sockets 401 and 402 (FIG. 4). Those of skill in the art would appreciate that the housing could take any desired shape and that the shape of the housing is not as important as the shape of the one or more input connectors.

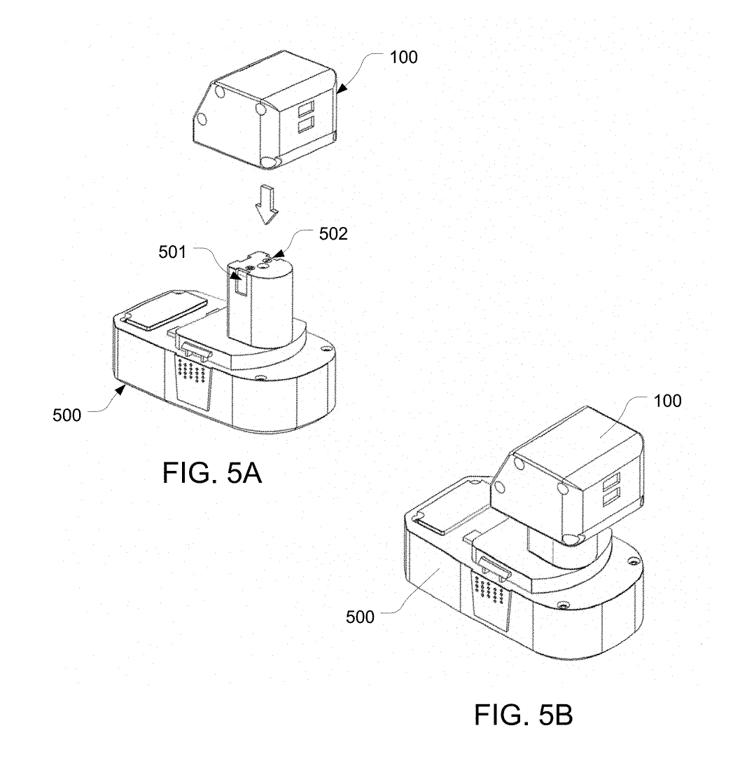

In one or more embodiments, housing 110 comprises further comprises a second female connector 150. As illustrated in FIG. 1B, the second female connector comprises an inverted well 150 for removably secured mechanical coupling of the housing 110 to a second distinct type male connector of a battery pack assembly by vertically sliding the housing 110 onto the battery pack male connector of the second distinct type battery pack's male connector. The second female connector 150 comprises a plurality of electrical contacts, e.g. pins 121 and 122, which are configured to securely and electrically engage with the electrical contacts of the battery pack 500, e.g. sockets 501 and 502 (FIG. 5).

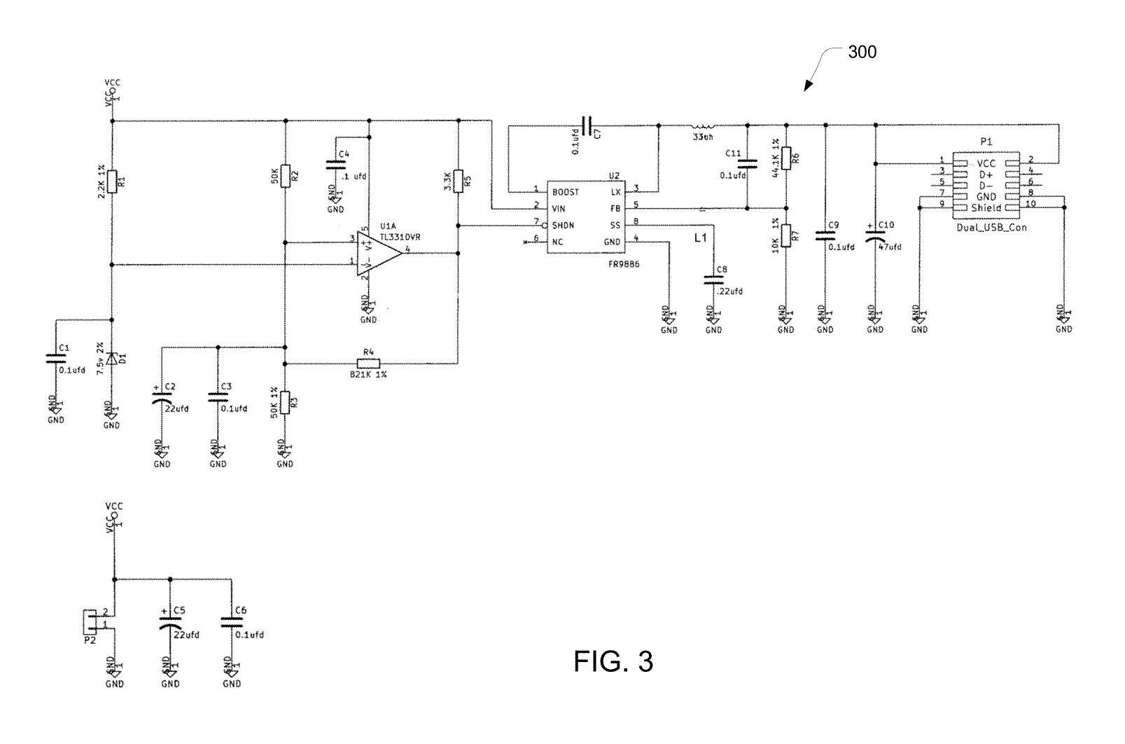

As illustrated in FIG. 1B, the input connectors, e.g. 140 and 150, comprises electrical contacts (or pins) 121 and 122 for electrically coupling to the terminals of an external battery pack. The terminal ends 121A and 122A, which are the proximal ends of the electrical contacts are exposed for coupling to the positive and negative terminals of an external battery pack, are coupled inside the inverted well 150 to the bottom wall 111 of the housing 110. The distal ends of conductors 121 and 122, i.e. terminal ends 121B and 122B, are coupled inside the housing cavity 101 to pins 1 and 2 of connector P2 of the power management unit 300, e.g. circuit diagram (FIG. 3). The terminal ends 121A and 122A of the housing electrical contacts 121 and 122 are configured to electrically engage in a secure manner with multiple types of battery packs. Those of skill in the art would appreciate that both input connectors may have the same electrical contacts or different electrical contacts, so long as both provide input power to the power management unit.

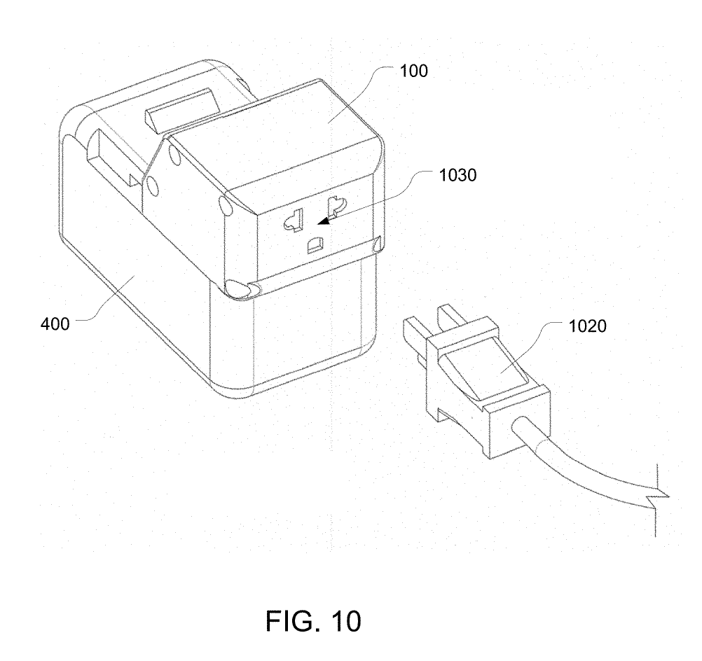

In one or more embodiments, housing 110 further comprises a window 107 (defined by openings 107(L) and 107(R)) for each output connector port 130. The window 107 securely fixes the output port 130 to the housing 110. Output port 130 may be a USB type connector or any other desired power output connector port. For instance, the connector port may be a 110 Volt or 240 Volt AC outlet, as illustrated in FIG. 10, in which case the power management unit will be configured to generate AC voltage output. In embodiments with USB output ports, the connector terminals may be as illustrated in connector P1 of the power management unit 300 (FIG. 3), for example.

FIG. 3 is a circuit diagram of the power management unit 300 of the universal power device in accordance with one or more embodiments of the present invention. As illustrated, in one or more embodiments, power management unit 300 comprises a converter U2, e.g. a Buck-Boost converter, which can accept a wide voltage range in order to be compatible with multiple type battery packs and output a fixed voltage. Those of skill in the art would appreciate that converter U2 may be a Buck or a Boost converter. These types of converters are generally known in the art.

The power management unit 300 takes the incoming electrical energy and processes it, if needed, to the needed specifications of the output. In one or more embodiments, the range of voltages from the battery pack that the power management unit can handle ranges from about 4 volts to about 25 Volts. For example, a Ryobi, DeWalt or Milwaukee brand lithium battery with 18 Volt DC, or DeWalt or Porter Cable battery pack with 20 Volt DC lithium battery are transformed to about 5 Volts by the power management unit 300 for a USB power output at port 130. Those of skill in the art would appreciate that the power management may also be configured for higher voltages.

In one or more embodiments, one or more adapters, e.g. 610, 710, and 810, configured to fit additional battery pack types may be coupled to universal power device 100 in order to utilize battery packs that have terminal configurations that are much different from those of the universal power device 100.

FIGS. 4A and 4B are illustrations of coupling the universal power device 100 in accordance with one or more embodiments of the present invention to a first cordless power pack 400. In this exemplary illustration, a first type battery pack 400 with terminals compatible with the universal power device 100 slides horizontally into the female connector 140 of the universal power device 100.

FIGS. 5A and 5B are illustrations of coupling the universal power device in accordance with one or more embodiments of the present invention to a second cordless power pack. In this exemplary illustration, a second type battery pack 500 with terminals compatible with the universal power device 100 slides vertically into the second female connector 150 of the universal power device 100.

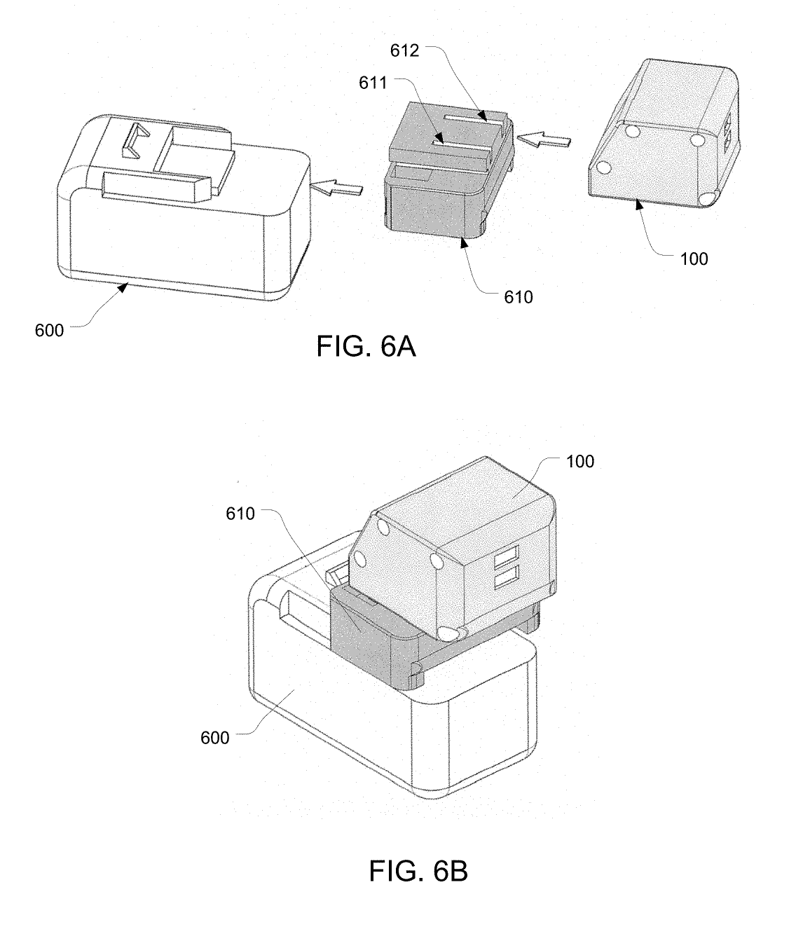

FIGS. 6A and 6B are illustrations of coupling the universal power device 100 in accordance with one or more embodiments of the present invention to a third cordless power pack 600 using an adapter. In this exemplary illustration, an adapter 610 is used to couple a battery pack with terminals that are much further apart than the universal power device 100. Thus, adapter 610 includes socket type electrical contacts 611 and 612 for coupling with connector 140 of the universal power device 100, while the adapter 610 is configured to provide electrical continuity with the terminals of battery pack 600.

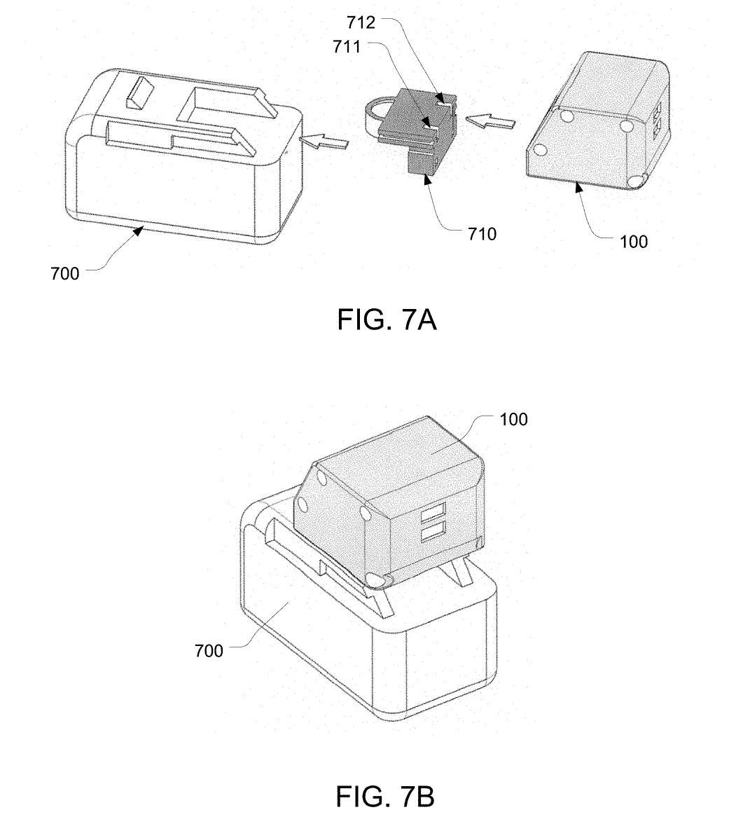

FIGS. 7A and 7B are illustrations of coupling the universal power device 100 in accordance with one or more embodiments of the present invention to a fourth cordless power pack 700 using an adapter. In this exemplary illustration, an adapter 710 is used to couple a battery pack with terminals that are much narrower than the universal power device 100. Thus, adapter 710 includes socket type electrical contacts 711 and 712 for coupling with connector 140 of the universal power device 100, while the adapter 710 is configured to provide electrical continuity with the terminals of battery pack 700.

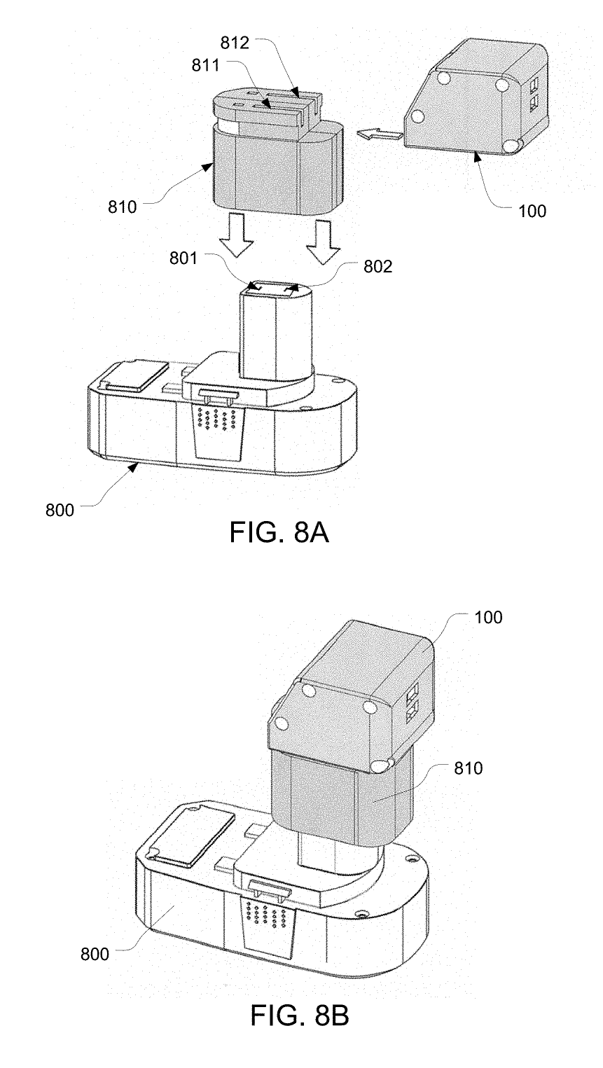

FIGS. 8A and 8B are illustrations of coupling the universal power device 100 in accordance with one or more embodiments of the present invention to a fifth cordless power pack 800 using an adapter. In this exemplary illustration, an adapter 810 is used to couple a battery pack 800 with socket type terminals 801 and 802 that are situated atop a protruding cylinder (which is much more common in Ni-Cad and Ni-Mh batteries). Thus, adapter 810 includes socket type electrical contacts 811 and 812 for coupling with connector 140 of the universal power device 100, while the adapter 810 is configured to provide electrical continuity with the terminals of battery pack 800.

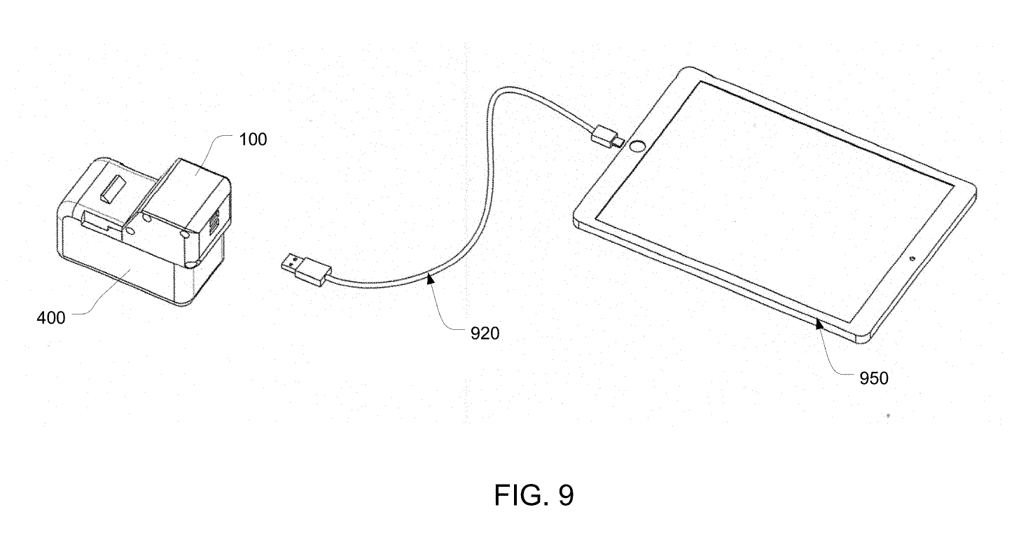

FIG. 9 is an illustration of coupling the universal power device 100 in accordance with one or more embodiments of the present invention to a smart device 950. For example, the universal power device 100 is slid onto a battery pack 400, e.g. Milwaukee, then a first end a USB cable 920 is inserted into a USB port 130 of the universal power device 100, and then the other end of the USB cable is plugged into a Smart device 950, e.g. smartphone, tablet, etc.

FIG. 10 is an illustration of the universal power device 100 with AC Voltage outputs in accordance with one or more embodiments of the present invention. As illustrated, an AC power plug, e.g. 1020, may be coupled to the output socket 1030 of universal power device 100 if the power management unit is configured with an AC voltage output socket 1030.

While the invention herein disclosed has been described by means of specific embodiments and applications thereof, numerous modifications and variations could be made thereto by those skilled in the art without departing from the scope of the invention set forth in the claims.

What is claimed is:

1. An apparatus for powering an electrical device from different battery packs comprising:
a housing;
a power management unit within the housing having an input terminal and one or more output terminals;
an input connector on the housing, the input connector having conductors coupled to the input terminal of the power management unit, wherein the input connector is configured to be removably and securely coupled electrically and mechanically to terminal contacts of more than one distinct battery pack type of a cordless tool device with voltage ranging from about 4 Volts DC to about 25 Volts DC; and
one or more USB output ports on the housing coupled to the one or more output terminals of the power management unit.

2. The apparatus of claim 1, wherein the power management unit comprises a Buck-Boost converter.

3. The apparatus of claim 1, wherein each terminal comprises a positive contact and a negative contact.

4. The apparatus of claim 1, wherein said input connector configurable to be coupled to a battery pack comprises an adapter coupleable to the housing and configured to fit and couple to terminals of a specific one of a plurality of battery packs.

5. An apparatus for powering an electrical device from different battery packs comprising:
a housing;
a power management unit within the housing having an input terminal and one or more output terminals;
a plurality of input connectors in said housing coupled to the input terminal of the power management unit, wherein each one of the plurality of input connectors is configured to be coupled to terminal contacts of a distinct battery pack type of a cordless tool device with voltage ranging from about 4 Volts DC to about 25 Volts DC; and
one or more output ports coupled to the one or more output terminals of the power management unit, wherein the one or more output ports comprises a fixed voltage power source.

6. The apparatus of claim 5, further comprising an adapter for coupling one of said plurality of connectors to a second distinct battery pack type with a wide DC voltage range.

7. An apparatus for powering an electrical device from different battery packs comprising:
a housing;
a power management unit within the housing having an input terminal and one or more output terminals;
a first input connector on said housing coupled to the input terminal of the power management unit, wherein the first input connector is configured to be removably and securely coupled, electrically and mechanically, to terminal contacts of a first distinct battery pack type with a wide DC voltage range;
a second input connector on said housing coupled to the input terminal of the power management unit, wherein the second input connector is configured to be removably and securely coupled, electrically and mechanically, to terminal contacts of a second distinct battery pack type with a wide DC voltage range; and
one or more output ports on said housing coupled to the one or more output terminals of the power management unit, wherein the one or more output ports comprises a fixed voltage power source.

8. The apparatus of claim 7, wherein the voltage range is between about 4 Volts and about 25 Volts.

9. The apparatus of claim 7, wherein the battery pack is the power source of a cordless tool device.

10. The apparatus of claim 7, further comprising an adapter for coupling said first input connector to a third distinct battery pack type with a wide DC voltage range.
